(19) United States
(12) Patent Application Publication
(10) Pub. No.: US 2009/0187271 A1
(43) Pub. Date: Jul. 23, 2009

(54) Method for depositing and retrieving prohibited items or products

(75) Inventors: Werner Heinlein, Kronach (DE); Olaf Clausen, Sonnefeld (DE); Lukas Clausen, Sonnefeld (DE)

Correspondence Address: COLLARD & ROE, P.C., 1077 NORTHERN BOULEVARD, ROSLYN, NY, 11576, US

(73) Assignee: Locktec GmbH

(21) Appl. No.: 12/321,441

(22) Filed: Jan. 21, 2009

(30) Foreign Application Priority Data
Jan. 22, 2008 (DE) 10 2008 005 444.5

(51) Int. Cl. G06F 17/00; H04Q 5/22

(52) U.S. Cl. 700/215; 340/10.1

(57) ABSTRACT

A method for not having to permanently relinquish prohibited items or products objected to at security controls. The prohibited items are instead provided with an identifying means, placed in a collecting container and stored by a storage service. The person participating in the system can, via the obtained identifying means, later claim the stored item at the storage service by way of the Internet and arrange for dispatch to an address to be indicated.

### CROSS REFERENCE TO RELATED APPLICATIONS

Applicants claim priority under 35 U.S.C. §119 of German Application No. 10 2008 005 444.5 filed Jan. 22, 2008.

### BACKGROUND OF THE INVENTION

The invention relates to a method for depositing and retrieving prohibited products or items, which are excluded from carriage in hand baggage, with use of labels and other identifications.

In commercial travel such as on an aircraft, a passenger is not allowed to carry so-called “prohibited goods and items”. Prohibited items are, for example, knives, weapons including replicas, scissors, razor blades, walking sticks with metal tips, tennis rackets, golf clubs and baseball bats, knitting needles, bicycle chains, knuckledusters, etc. Moreover, products such as liquids, alcohols, creams and perfumes cannot, in specific volumes, be carried when boarding an aircraft. If such items and products are found in the carry-on baggage of a passenger at the security control, the passenger is allowed to pass the security control only when these items and products have been handed over. These products are thrown into waste containers and later disposed off by airport personnel.

Alternatively, at some airports, the passenger has the opportunity of subsequently giving up the prohibited items at the check-in desk as hold baggage, depositing the items at the airport at the baggage store or in a locker until his or her return, or finding a post or courier service in order to send the items to the address desired by the passenger. For this purpose, the passenger has to leave the security zone of the airport again. This is inconvenient and time-consuming. Thereafter, the passenger has to queue-up again at the security control and undergo a security check once more.

This is all very inconvenient and time-consuming and can even cause the passenger to miss his or her flight. Accordingly, the airline passenger usually hands over the item or the product at the security control and is annoyed about the loss, which can even lead to arguments with the security personnel.

A similar problem is present at large events, for example, open-air concerts, sports events, political events, etc. The visitor is not allowed to carry “prohibited products and items” to the event and has to hand these over to security personnel. The event organizer does not offer any alternative for deposit and later recovery of the items. Accordingly, these items are thrown into waste containers and disposed of by the event organizer. The invention can also provide assistance here.

A goods management system for storage of goods is described in US Patent Application Publication No. 2006/0122858 A1, in which after receipt of the goods, an input of the goods into the goods management system is carried out. The goods are in that case at least partly imaged and the image stored therewith. The images can be made available to a remote user. The user can also cause the goods to be processed. The reprocessed goods can be received again in the store. Moreover, a recording of different sub-regions of the goods management process is provided. The storage can be designed to be automated and computer-controlled. It is also possible to store goods ordered in accordance with defined structures.

U.S. Pat. No. 4,634,849 describes using multi-part labels in connection with airline baggage so as to be able to feed the items of baggage to specific conveyor belts in a baggage transport system. The label consists of a base part to which a plurality of individual labels is removably attached. At least two labels are attached to different parts of the item of baggage and the further labels are detachable from the support base. These can be attached to, for example, the ticket envelope or positioned at a place to be carried by the passenger or baggage owner. The two labels attached to the baggage contain a first coded item of information which can be machine-read, wherein the coded items of information are representative for identification of the item of baggage during transport. This relates to known methods for checking-in of baggage.

In addition, a two-part label is described in U.S. Pat. No. 891,593, which consists of a tag and a tear-off part, which, for example, is carried by the passenger of a passenger train, while the first tag part is fastened to the baggage. The details on the two sections are identical and in readable form. At the baggage check-in, the separated section is handed over to the person checking in and serves at the receiving location as evidence of receipt of the transported item of baggage. Similar actions are known by baggage check-in counters at railway stations, at which items of baggage can be deposited for a specific period of time.

### SUMMARY OF THE INVENTION

It is therefore an object of the invention to provide a method that is not time-consuming and, without obstructing the course of security checks, can be used by the owners of prohibited items without having lose the items to be relinquished. Moreover, the course of the security check is not appreciably impaired by the handing over of such prohibited products and items by the owner, and the owner can regain the relinquished items at a later point in time.

The invention comprises the following method steps:

a) providing the item with at least one first part of a two-part identification such as a label, the first part having at least one first identifying means, identification having a second part with at least one second identifying means and a communications address of a storage service, or placing or inserting the item in a container such as a padded envelope, a dispatch bag or a dispatch box provided or printed with such a two-part label or identification. The second identifying means is applied to the second part in numerically and/or alphanumerically coded or uncoded form and is readable. Thus the first identifying means is applied in barcode and/or numerically and/or alphanumerically coded readable form and/or encoded in another manner not corresponding with the first identifying means;

b) detaching or separating or taking the second part of the identification and carrying the same by the person handing over the product and/or the item;

c) storing the item in a store of a storage service;

d) calling-up a claim page from a computer of the storage service by way of an electronic communications system by means of display apparatus with connected input means by the person who is in possession of the second part of the label or the identification or the second identifying means;

e) communicating the second identifying means which is indicated on the second part of the identification, by entry in a writable field in a page shown on a display of the display apparatus and transmitting a request to the storage service for forwarding the item, which is stored under the same or an associated first identifying means, to a specific delivery address, by the person who is in possession of the second part of the label or the identification; and

f) forwarding the stored item to the indicated delivery address.

The method according to the invention simple to operate, the capital costs are very low and no kind of technical outlay, such as power connection, data lines, automatic equipment or the like, is necessary on site at the security controls. Equally, it is possible to resort to existing logistical systems. Moreover, the movement of products takes place very rapidly and with complete anonymity.

If at the security control a prohibited item is found, it is placed by the passenger or the security service in, for example, an envelope. A coded first identifying means, which is not readable by the usual observer, but which can be read out by machine, for example by a scanner, is marked on the envelope in a first identification. The passenger receives an identical or associated identifying means, which is applied to a second part of the identification or the label—a claim label—in readable text or in number/letter combinations, which serves as evidence for later recovery of the item or the product.

The process at the security control requires only a few seconds and does not impede the procedure. The passenger later has plenty of time to claim his or her item. The system can also be used for the purpose of removing items from items of baggage so as to not exceed weight limits. Excess baggage can be treated in similar manner.

The invention enables long items such as baseball bats, billiard cues, golf clubs, walking sticks or umbrellas with metal tips, and items placed in bags, pouches or envelopes, such as knives, scissors, bottles, etc., to be provided with the first part of the identification or label, which is a product label, while the owner of the second part of the label or identification takes it with him or her or accepts it from an operative of the security service. The item itself is not intermediately stored in a personalized manner by the labeling or identification. The intermediate storage can in that case take place in a collecting container or also in a deposit compartment within the security zone of the terminal building. If the item is small and can be stored in a concealed manner, it should be placed or inserted in a padded envelope, dispatch bag or dispatch box. The dispatch receptacle is closed after insertion of the item. For example, it can be a padded envelope having an adhesive closure which is self-adhesive and by way of which the padded envelope is sealable. With sealing of the padded envelope, the item can be stored anonymously.

The label can already be printed on or stuck to the padded envelope itself. The second part of the label is formed to be detachable so that it can be pulled off or separated. The label can, however, also be printed by a printer and only then stuck to the padded envelope. In addition, the printer can be alongside the collecting container or placed on this or integrated therein. The second part is in that case formed as a detachable label and can be separated or pulled off, for example it can be an adhesive label part which is printed at the same time. If it is a folded label part, then it can be separated. For this purpose, the label has a perforated parting line along which separation can be quickly undertaken by hand in simple manner.

However, the label can, particularly for attaching to items, be formed as a tag fastenable to the item by means of a wire, cord, gum or glue. The second, separable part is located at the tag itself and can be separated in a simple manner. It is important that an identifiable identifying means designed to be anonymous is applied not only to the label part remaining at the item, but also to the second label part carried by the item owner making the handover, since, with respect to processing, it is not possible at the check-in for any address to be exchanged or applied. The identifying means on the first part, which remains at the item or the padded envelope, can be applied coded in readable text and/or coded as a barcode or as a pictorial code. Equally, the receiving point can be marked, for example “FRA1” or “FRA2” for “Frankfurt Airport Terminal 1” or “Frankfurt Airport Terminal 2” or “MU1” or “MU2” for identification of the receiving station. The components of the identifying means listed subsequently can contain alphanumeric lines or also other barcodes or other imprints, such as coded pictorial imprints.

An associated or identical identifying means is applied to the second part in coded form as alphanumeric characters so that the owner of the second identifying means can, when claiming the stored item, provide identification by way of a website of the storage service. In this connection, he or she must always provide identification, which is effected by the particulars of the coded identifying means. In addition, it can also be checked by the computer of the storage service whether the person possessing the second identifying means is identical with the address data to which the delivery shall be made. For this purpose, the computer accesses, for example, an electronic residence registration list or a telephone book. If the items are released only against payment of an administration, handling, storage or dispatch fee, then the owner can initially undertake payment of the fees or allow debiting of the fees so that the dispatch or release can be effected. This, too, takes place electronically by successive display of an input field on the screen of the display apparatus, for example by means of a remote control.

An item provided with a first part of a label or identification, a padded envelope, a bag or a box is placed by the owner or the security operative in the provided compartment at the receiving point or temporarily deposited in a collecting container. The storage as such takes place after collection at a store of a storage service. The storage service can be ensured by, for example, a parcel service or by a delivery service or also by a forwarding agency. In the store, the items or the packages in which the items are located are registered. This is carried out automatically by scanning the identifying means on the first label part. The store administration system can also assign, on the basis of the detected identifying means, a storage place for the item so as to be able to more easily find the item again. The storage space is then similarly stored in association with the item. Depending on the respective store administration, this can also be, for example, the day of entry. This day of entry can also be recorded on the label, particularly when the label is printed at the security control. Even the time of handing over can be recorded on the label parts if the label is printed out.

If the owner of the stored item decides to later claim the item after his or her journey or after the visit to the sports event, etc., then he or she is required to identify himself or herself by the second label part in order to have the non-personalized item forwarded. For this purpose, for example, the storage service can provide, by way of the Internet, websites in which writable fields are provided in which the address or delivery address is to be entered as well as the identifying means, which the owner can read from the second label part, and also the bank account details. If the requisite fees are paid, then there is no obstacle to dispatch of the stored item to the dispatch address indicated by the owner of the second label part.

The identifying means can be present at least on the first label part in the form of pictorial codes, for example in a two-dimensional barcode, such as are printed on, for example, German railway tickets ordered by way of the Internet. The identifying means can, however, also be stored in an RFID chip, a readable transponder with memory, which can be read out by means of generated high-frequency fields. This technology is known and is used for safeguarding goods and for tracking movement of goods, wherein these chips can also be applied to adhesive strips which can be attached to the merchandise itself or to the packaging thereof. The transponder system operates very reliably and is also suitable for detection of data within a defined larger scanning range, so that, when detecting or scanning continuously, the data are rapidly detectable and made available to the storage service so that at the time of collection, an identification of the item and a comparison with the identifying means which the owner presents are possible. If the identifying means is additionally applied to the second label part in this form, the input can be read in by way of a scanner connected with the display apparatus, for example a home computer or a laptop.

In principle, the storage and also the storage service can be operated on site, for example in an airport or in the lost property office of the city hall of a municipality in which is located the sports venue or discotheque at which the visitors are subjected to a security check. However, a central store is also possible, for example for the Bavarian airports and/or stadia, for example, in Nuremberg. A central storage service is also possible so that items collected from all receiving points within a region can be stored. The storage time should be fixed, having regard to the anticipated quantity of items, to eight to twelve weeks. The conditions are entered in the web pages of the storage service. If the anonymously stored items are not collected or claimed then, these can be auctioned, sold, given away or destroyed by the storage service. The appropriate business conditions must be advised on this.

The mode of operation of the method can be summarized, by way of an example, as follows:

At the security control, the rejected prohibited items, which are the subject of objection and which are packaged or unpackaged, are provided with a label or an identification. Apart from the first identifying means, i.e. the product identifying means which identifies the item, the receiving point, data about the size of the wrapping, weight of the item or of the product—established by way of a weighing machine—and the tracking and trace number of a parcel service can be applied in readable form, for example alphanumerically as a PIN code, or in unreadable coded form, for example as a barcode or pictorial code, and/or stored in digital form in an RFID transponder on the first label part or identification part, i.e. the product label. If the label is not printed out, specific details, such as weight, are not registered. Apart from the second identifying means, the claim identification, the address or at least the URL and/or the telefax or telephone number of the storage service are recorded on the second label part or identification part, i.e. the claim label or the receipt. The second identifying means, i.e. the claim identifying means, can also be applied to the second label part in identical form according to the first identifying means or in an associated form, but at least in a readable form so that a reader or scanner does not have to be used on the part of the owner for reading. The second identifying means can also be located behind a scratch coating so that it cannot be seen by unauthorized persons without further action. The second part of the label or sticker is separated and is carried by the passenger or the owner, who makes the handover, of the item. The Internet address of the storage service and operating instructions for the system are also printed on this part.

If the user of the system decides, for example after two or three weeks, when he or she has returned from a flight, to claim the item then he or she makes a claim with the operator of the storage service.

The user of the system can identify himself or herself, for example by way of an Internet page of the service operator, by input of the identifying means visible on the second label part or identification part and enters this in an entry field on the display by a keyboard as well as a delivery address, to which the item is to be sent, at an indicated and/or marked place. In that case, it is self-evident that the identifying means is to be coded so that it does not permit recognition of any sequence. The coding should be effected, for example, by means of a random generator; it has to be ensured that the code exists only once. If the storage service requires a fee for the storage and dispatch, then a “payment request” can be provided on an associated Internet page. After receipt of the remittance, for example by electronic direct debiting or payment by credit card, the storage service ensures that the stored product or the stored item is sent to the notified address.

The invention intends by the terms “label” or “identification” to mean not only adhesive, printed labels or identifications on which the identifying means are printed, but also any form of imprints or texts of fields on envelopes, padded envelopes, dispatch bags or dispatch boxes insofar as the second part is designed to be able to be torn off, removed or separated. These can be, for example, tear-off tags to which the collection code or the identifying means and/or the identifying numbers is or are applied. Moreover, by “label” according to the invention there are also to be understood such identifying means which are included in RFID chips which are applied in or to a wall of the boxes, envelopes, padded envelopes, dispatch bags, dispatch boxes or cartons, when the second information part, which is to be carried, at least in printed form, is removable from the packaging or separable therefrom. The second part of the label can be, for example, a card removable from the packaging. This can also contain an RFID transponder or RFID chip with the identifying means or an associated coding, which is readable by an appropriate reader connectable with a personal computer. The identifying means and identifying numerals can similarly be applied in barcode or pictorial code form.

The two codes can also contain identifying numerals which, on input or automatic recognition in the store, access an associated server. This is required in certain circumstances, since in the case of a national, pan-European or worldwide use of the method, the amounts of data could be too large to be able to be efficiently processed at one server. In such cases, a number of servers can then be installed remotely, which can also be linked with one another so that the call-up procedure can be carried out by way of uniform Internet pages. If, for example, the identifying number is input by the owner of the second label part, then the following processing page of the storage service is automatically loaded and, optionally, the connection with a client server produced. With further processing on the part of the storage service or the logistical operator, direct access to the corresponding server is carried out by a local processing software.

The codes can also include identifying means specifying the size of the wrapping, carton, box or goods, for example bulky goods, and/or the weight, the mode of dispatch and other movement data. The handling and the dispatch costs can thereby be determined in advance. A later determination of characterizing values at the time of entering storage is not required. The corresponding codes can be detected in a simple manner, particularly at the time of handing over the item if by way of selector buttons, such as a bulky goods button, the identifying means is preset when a label is removed or, however, if the apparatus detecting the item and/or a weighing machine are included in the collecting box in order to issue an appropriate identifying means or code associated with the goods. Such codes can, for later tracking, be linked at the databank side in a simple manner with the tracking and trace number of the parcel service or already contain a tracking and trace number, so that tracking can be ensured in simple manner.

It is also possible to register envelopes, padded envelopes, etc., which are handed over and which possess identifying means, at the time of distribution to the computer system so that misuse of these packaging items can be prevented. It is also possible to provide the second label parts with identifying means serving only for association with a coding in the first part. This can also be used to establish when the item or the packaging with the item is to be sent, when the owner of the second part has identified himself or herself as authorized party and indicated his or her delivery address, and when the fees for the storage and dispatch have been paid.

In every case, the party handing over the product can assume that he or she can claim the stored item over a period of time defined by the storage service. In addition, a quick and simple completion at the time of handing over is given, so that checking-in of a person in the security zone is delayed. If the user of the system is a passenger of an aircraft, he or she can, for example, continue his or her journey in peace with the certainty of being able to recover his or her stored item.

If the maximum storage time, for example six weeks, has expired, then the storage service can dispose of, auction, supply to charitable institutions for use and sale, or discard the deposited items and objects. The business conditions of the storage service can be called up in each instance by way of the Internet. They can, however, also be supplied by e-mail or post to the interested party, as is usual in the case of electronic business programs.

In order to create incentives to take advantage of such a service, it is possible to formulate the running costs, fees and dispatch costs to differ in relation to the value of the goods handed over or to entirely dispense therewith, particularly not to levy such fees if the objects are directly collected from the receiving point or from the depot of the storage service, in which connection the location of the storage service and the store do not have to be identical and the storage service can have different depots. In addition, dispatch does not have to be undertaken by the storage service. Rather, a service provider, for example a delivery service or a parcel delivery service, can look after this. In addition, participation in the system is provided in the manner that, with the dispatch of an item to the owner of the second label part or identification part with the identifying means disposed thereon, items which are not collected and are thus expired in terms of time can accompany—without cost and as a gift—the required dispatch and then pass into the possession of the addressee if he or she accepts these. In addition, presents can be added or advertising material included, by way of which financing of the system is also possible.

In order to prevent tampering with the electronic ordering of the dispatch, the computer of the storage service, on calling-up of the retrieval page, can also transmit a security code which is to be entered in a prescribed mode and manner by the user in a field provided for this purpose. This security code can be coded with the other data which are input by the claimant. The coding can be carried out automatically on the server side of the storage service with use of the security code.

The claim system can be explained, by way of an example, as follows:

The person in possession of the second identifying means initially calls up the Home page of the storage service by way of an Internet computer. The person secures, from the called-up computer of the storage service, display of the Home page on the display. The Home page can also contain, for example, a language selection, for example German/English. If the user selects a language, than the succeeding page appears in this language and requests entry of the coding readable as collection code on the second label section or indicated as identifying means. This can consist of, for example, three blocks. At the same time, however, it is possible to transmit, together with the sending of the call-up page of the computer of the storage service, a security code which has to be input in a further field. Through actuation of a “next” field on the display, a further page of the service computer is transmitted, which can contain, for example, apart from an explanation, also an acknowledgement that the item is in the dispatch store and can be sent. If the system has international orientation, it is possible to provide, for example, a country selection field from which the receiving country can be sought. This is similarly selectable by cursor selection. Currencies in which the user can select payment of the fees can be indicated in a further selection field. This field initially serves the purpose of determining and displaying the dispatch costs. A further selector button than leads to a cost overview on the display. In addition, an interrupt button can be provided on each page by means of which the respective procedure can be interrupted. After input of the confirmation command, the cost overview of the dispatch costs and/or other fees (handling costs and customs fees) appears in the succeeding page. The user can thus decide whether he or she would like to outlay these dispatch costs in order to recover the item or whether he or she declines. If another currency is preferred, it is also possible to provide a return selection field which can be selected by the cursor. On selection of the “next” field, the field “enter address” appears. This page requests entry of the recipient's address with all details to be queried. The field is, for example, subdivided into title, name, first name, name, company, e-mail address, street and house number, Zip code, Postcode, place, state, country, which is already inserted by the preselection.

Through actuation of a reset field, the procedure is reset or, through actuation of an interrupt button, interrupted. Through actuation of the “next” field, the procedure is continued. A page with details of the payment method appears after actuation of the field “next”. For preference here, for example, a “credit card” field or “prepayment by bank account transfer” field can be clicked. When this field has been completed, it is possible to move on again. The claimant then obtains an overview in which all data are collated, including the cost overview, payment and advice of the general business conditions, which is to be indicated with an X or cross so that these are acknowledged. If the person requesting delivery signifies agreement with the business conditions, there is confirmation to him or her that the dispatch takes place shortly. In addition, advice can be provided that through entry of the collection code, the goods dispatch can be tracked at any time. Receipt of the item by a delivery agent is registered by the computer and stored as dispatch date, which can be verified by input of the collection code by the party calling up requesting delivery.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a flow chart, relating to an airline passenger;

FIGS. 2a,b,c show a padded envelope and the provided labelling with the operating sequences;

FIGS. 3a,b,c,d show a label according to the invention with handling data;

FIG. 4 shows a collecting container such as can be located in the security monitoring zone of an airport, and

FIG. 5 shows a further example of a collecting container.

### DETAILED DESCRIPTION OF THE PREFERRED EMBODIMENT

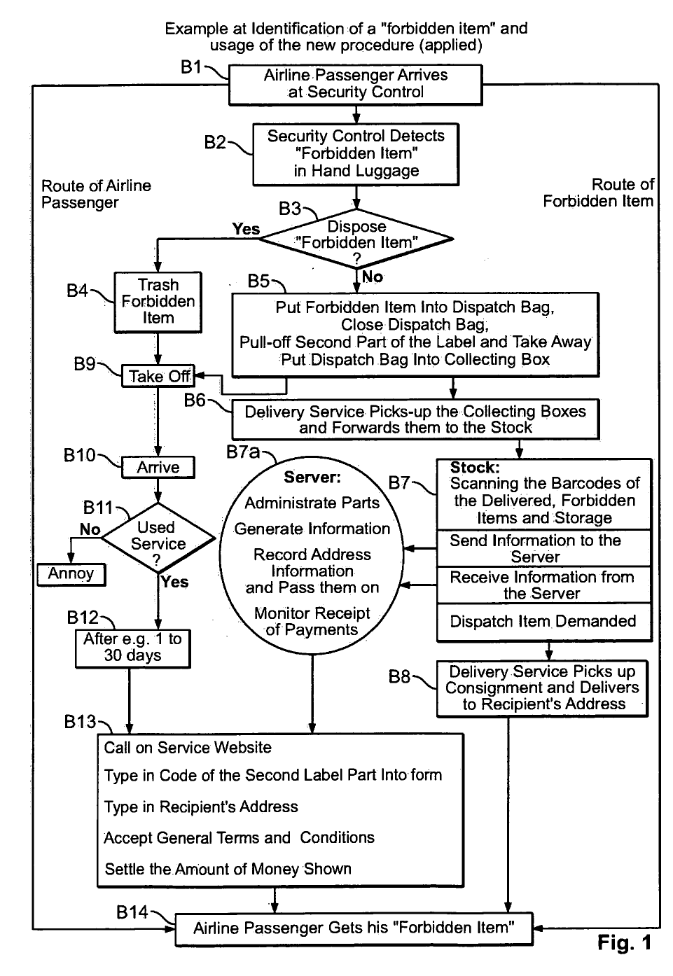

A flow chart, from which the functioning of the method for a passenger of an aircraft is apparent, is illustrated in FIG. 1. Block B1 symbolizes an airline passenger. The passenger goes together with his or her hand baggage to the security control illustrated in Block B2, which searches the passenger and the hand baggage for prohibited items and products. If the security control does not detect any prohibited items, the passenger can take off, which is symbolized by the Block B9. If a banned item is found (Block B3), this is disposed of in the usual manner, which is symbolized in Block B4, or the owner places the item in a padded envelope, which is labeled in accordance with the invention, as indicated in Block B5. The padded envelope is closed and thrown into a collecting container. The owner, or also the security service operative, previously separates the second label part, which contains at least the collection identifying means, and gives this to the owner, who carries it. Thereafter, the passenger can similarly take off (Block B9).

A collection service collects the collecting container from the airport and takes this to a central store of the storage service, which is illustrated in Block B6. The product identifying means and possible further data on the first label part are scanned in the central store and the digital data transferred for administration and storage in a databank at a server B7a. Moreover, the storage place can be determined by the server at the same time and registered. The items are then stored, according to kind, in accordance with Block B7.

When the passenger returns from his or her trip or has arrived at the destination, which is symbolized by the Block B10, he or she can decide whether or not it is desired to use the dispatch service according to Block B11. He or she then has, for example, thirty days to consider whether or not the stored item is to be claimed, which is symbolized by Block B12. If the person decides to claim the stored item, he or she can call up, for example by way of the Internet, the page of the storage service in accordance with Block B13 and complete the question fields. He or she can in this connection obviously also authorize another person, for which purpose, however he or she has to hand over the second label part or communicate the retrieval identifying means recorded thereon. The passenger concerned or the holder of the second label part enters in the display field of the web page the retrieval identifying means and the recipient's address. The server of the store administration can at the same time calculate and display the delivery fee as well as generate a calculation display field, which is similarly symbolized in Block B13. The delivery fee can, for example, be paid in known manner by means of credit card debiting. When this has taken place and the payment receipt checked, the storage service can associate the previously anonymously filed item with the owner and send it to the indicated recipient's address (B7). A parcel delivery service, which is symbolized by the Block B8, serves this purpose. The parcel delivery service collects the parcel and transports the item to the addressed owner, which is illustrated in Block B14. The airline passenger or the person authorized by him or her receives the item according to Block 14.

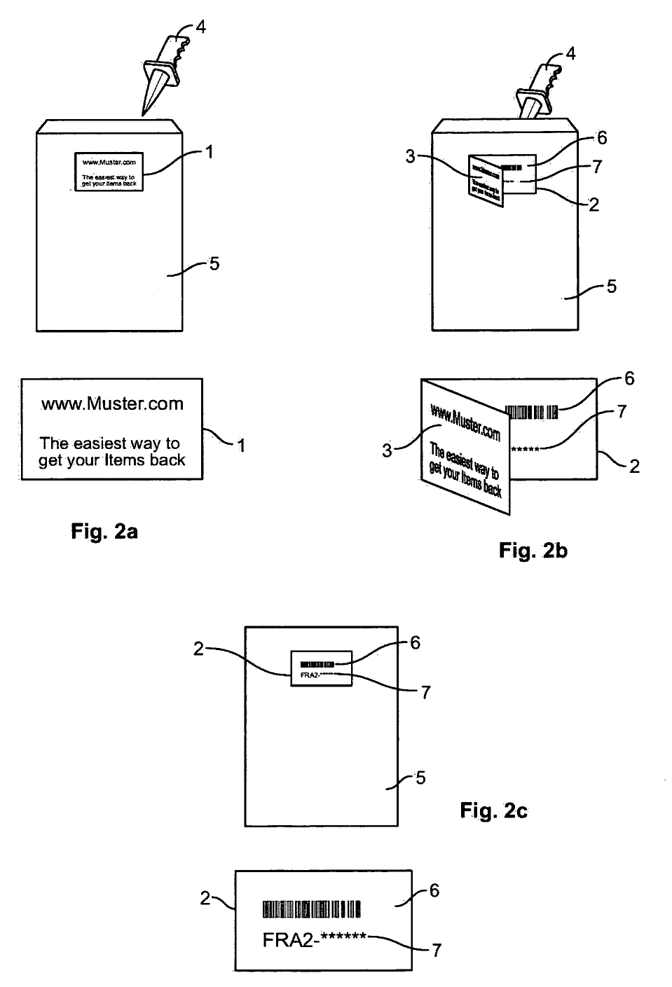

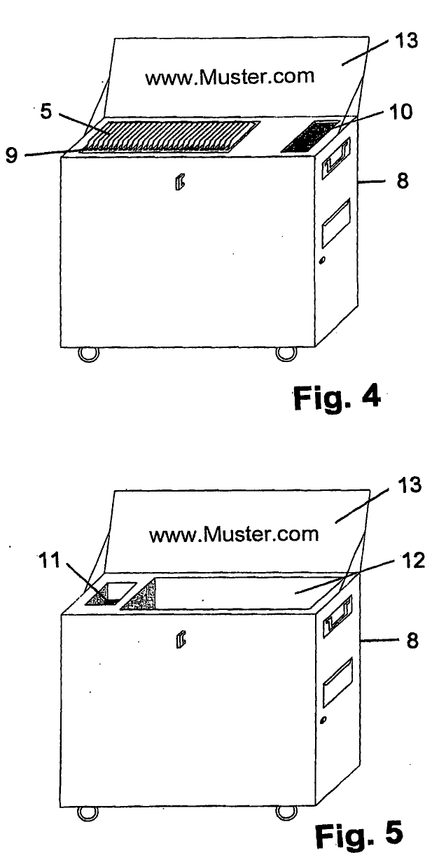

The insertion of an item 4 into a padded envelope 5 and the labeling as well as the further steps of acceptance are illustrated in FIG. 2. The item 4, for example a knife, which is not allowed to be carried by an airline passenger, is inserted into a padded envelope 5 present at the security control. The checked person, who still has the knife 4, takes the knife 4 and places this in the padded envelope 5, which is apparent from FIG. 2b. The padded envelope 5 has a label 1, namely a folded label, as apparent from FIGS. 2a and 2b. The first part 2 is firmly attached to the padded envelope, while the second part 3 is folded thereover so that this part 3 stands up, as apparent from FIG. 2b, and can be separated. The identifying means is visible on the first label part as a barcode and a coded statement with inclusion of the acceptance location FRA2, for example Frankfurt 2. Disposed on the inner side of the separable second part 3 of the label 1 is an identifying means which is either associated with the identifying means 6 or 7 or, however, identical therewith, but in a readable script form so that this can also be read by the user of the system. The separation of the second part 3 of the label 1 is apparent from FIG. 2c. This part is then carried, while the envelope with the first label part 2 is thrown into or placed in a collecting container, as is apparent from FIGS. 4 and 5. This is further discussed later.

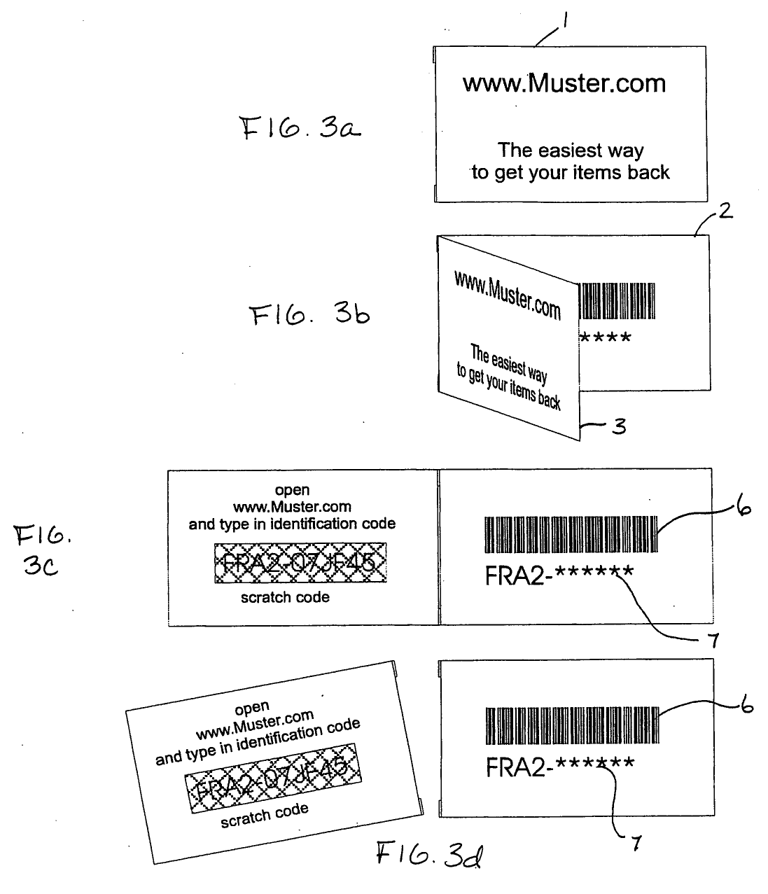

The label itself is illustrated again in FIGS. 3a, 3b, 3c and 3d. It can be a label which is subsequently stuck to the padded envelope or, however, also already applied thereto. Printed on the upper side of the second part 3 of the label 1 is the Internet address under which the user of the system can later turn to the storage service in order to have the stored item dispatched. Visible under the folded-up second part 3 is the first part 2 which—as already been described with reference to FIG. 2—has a barcode 6 containing the identifying means or also another coded identifying means 7, which enables individual association with the item, but in anonymous form. The corresponding counter-identification code or the identical code is applied in plain text, namely in alphanumeric character sequences, to the inner side of the second part 3 of the label 1, for example FRA2-07JF45. So that this is not visible to everybody, it can be covered by a coding able to be rubbed off. Moreover, an operating instruction is printed on. This part is now separated in accordance with FIG. 3 and taken by the passenger and can then be later used for retrieving the item, as described with reference to FIG. 1.

FIGS. 4 and 5 show two collection containers 8, which are constructed as roller bins. An upper compartment 9 for padded envelopes is provided in the collecting container 8. Disposed in this are the padded envelopes 5, which can be individually removed.

In addition, an insertion slot 10 is located at the top in the cover. A removed padded envelope, filled with an item, can be introduced, in closed form, in simple manner into the insertion slot 10. Prior to this, however, the second label part 3 has to be separated from the label.

FIG. 5 shows an embodiment of a collecting container 8, which is similarly rollable, with a compartment 11 for reception of labels 1. The user can remove such a label from the compartment 11 and fasten it to the item itself. The item can be put into the large opening 12 of the collecting container. Both containers are closable by covers 13 so that after filling, for example at the end of the working day, they can be removed by a collecting service from the security control zone of the airport and replaced by new ones. The collecting containers 8 are then taken to a central store and there the individual items or the padded envelopes with the items are registered and stored, so as to store them for a specific period of time to be ready for retrieval.

Accordingly, while only a few embodiments of the present invention have been shown and described, it is obvious that many changes and modifications may be made thereunto without departing from the spirit and scope of the invention.

What is claimed is:

1. A method of depositing and retrieving products or items which are prohibited from being carried in hand baggage, comprising the following method steps:
a) providing a two-part identification, a first part having at least one first identifying means, and a second part having at least one second identifying means and a communications address of a storage service;
b) placing said first part directly on a prohibited item, or placing or inserting the item in a container having said two-part label or identification thereon, wherein the second identifying means is applied to the second part in a numerically or alphanumerically coded or uncoded form and is readable, and the first identification means is applied in barcode and/or numerically and/or alphanumerically coded readable form and/or encoded in another manner not corresponding with the first identifying means;
c) retaining the second part of the identification by the person handing over the product and/or the item;
d) storing the item in a store of a storage service;
f) uploading a claim page from the computer of the storage service by way of an electronic communications system with a display apparatus with connected input means by a person who is in possession of the second identifying means;
g) communicating the second identifying means by entry in a writable field in a page shown on a display of the display apparatus and transmitting a request to the storage service for forwarding the item to a specific delivery address, by the person retaining the second part of the identification; and
f) forwarding the stored item to the delivery address.

2. The method according to claim 1, further comprising:
intermediately storing the item in a collecting container at a receiving point and taking the collecting container to the store of the storage service;
registering at least the first identifying means by the storage service;
classifying and storing the item or container in the store according to defined criteria; and
carrying out a recognition comparison of the first identifying means with the second identifying means, or a comparison of an association of the two identifying means, by the computer of the storage service.

3. The method according to claim 2, wherein the first identifying means is automatically read out in the store by a reader or detector and stored in a databank of the computer of the storage service, and wherein the second identifying means is checked by the computer to see if the item is located in a store of the storage service under the same or an associated first identifying means.

4. The method according to claim 1, wherein the two parts of the identification are placed in an area of the item or container to lie one below, alongside, above or on the other and adjacent or offset in terms of spatial position and wherein the second part is separable from the first part, and wherein the parts are directly printable on an envelope, a padded envelope, a dispatch bag or dispatch box.

5. The method according to claim 2, wherein code numbers are provided which enable automatic access to a specific computer of a databank or of a server when read out in the store or which, when entered by the claimant, address the specific computer, the databank or the server to automatically secure display of a claim page by way of the communications system.

6. The method according to claim 1, wherein at least one of the first and second identifying means additionally contains data about the size of the container, or data about the weight or type of the item.

7. The method according to claim 1, wherein at least the first identifying means contains additional tracking information which can be linked with or contains a tracking and trace number of a parcel delivery service.

8. The method according to claim 1, wherein a receiving point is recorded in coded form to be concealed, or is visible or readable on at least the first identification part.

9. The method according to claim 4, wherein the second part is detachable from the first part, or is separable from the first part along a fold line.

10. The method according to claim 8, wherein the first or second identifying means includes the coded receiving point, or the receiving point is assigned to first or second identifying means by a databank of the server.

11. The method according to claim 1, wherein the first identifying means is stored on at least the first part in an RFID-memory which is read out by a reader of the storage service, or the first identifying means contains codes whose validity is checked by a computer by way of a databank.

12. The method according to claim 1, wherein the second identifying means is printed in readable form with numerical characters and/or letters on the second label part or identification part behind a scratch layer or detachable cover.

13. The method according to claim 1, wherein the second identifying means is additionally stored in the second part in an RFID chip which is read out by a reader connectible with a computer.

14. The method according to claim 1, wherein the identification is printed out at a receiving point by a printer, or is preprinted and withdrawable from a dispenser or a roll, wherein at least the first part is adhered or attached or fastened to the item or the container, and wherein the second part is printed as a separable tag.

15. The method according to claim 14, wherein the identification is transmitted to a server of the storage service during printing.

16. The method according to claim 1, wherein contact information of the storage service is recorded as correspondence address at least on the second part of the identification.

17. The method according to claim 1, wherein a claim for the item is carried out by way of a website or several websites having entry fields for entry of the identifying means, in which the identifying means of the second identification part is entered, and having an address field for entering the delivery address.

18. The method according to claim 17, wherein an additional field is included on the retrieval page for entry of data for completion of payment of a handling, storage and dispatch fee.

19. The method according to claim 17, wherein an entry field for desired delivery dates or for a desired mode of dispatch is provided.

20. The method according to claim 17, wherein the storage service transmits a dispatch confirmation to the customer.
